(19) United States
(12) Patent Application Publication
(10) Pub. No.: US 2003/0185428 A1
(43) Pub. Date: Oct. 2, 2003

(54) Anomalous shadow detecting apparatus

(75) Inventor: Hideya Takeo, Kaisei-machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/394,204

(22) Filed: Mar. 24, 2003

(30) Foreign Application Priority Data
Mar. 28, 2002 (JP) 090562/2002

(51) Int. Cl. G06K 9/00

(52) U.S. Cl. 382/132; 382/170

(57) ABSTRACT

Disclosed herein is an anomalous shadow detection apparatus capable of reducing the fluctuation in the detection accuracy due the difference in the distribution pattern of the mammary glands in a mammogram. An image categorizing means categorizes, based on image data, mammograms according to the distribution pattern of the mammary glands appearing therein. A detecting means detects the anomalous shadows appearing within the mammogram by use of a predetermined method that has been determined based on the mammary gland distribution pattern of the target mammogram.

### BACKGROUND OF THE INVENTION

1. Field of the Invention

The present invention relates in general to an anomalous shadow detecting apparatus, and in particular to an anomalous shadow detecting method for detecting anomalous shadows based on the image data representing a mammogram.

2. Description of the Related Art

It is a wide spread practice in the field of medicine to diagnostically read a radiation image of the mammary glands to discovery the existence and the location of a diseased tissue, or to observe the state of a diseased tissue to ascertain the state of advancement of the disease, etc. However, because the diagnostic reading of radiation images is influenced by the experience and skill level of the diagnostician, it cannot be guaranteed that an objective result will be obtained.

For example, in diagnostically reading a mammogram (a diagnostic radiation image of the mammary glands) obtained for the purpose of conducting an examination for breast cancer, it is necessary to discover therein the anomalous shadows such as the shadows of tumors and the shadows of microcalcifications, which are indications of breast cancer, and depending on the ability and experience of the diagnostician, it is not necessarily a forgone conclusion that the anomalous shadows will be accurately discerned. Therefore, a method is sought whereby anomalous shadows, starting with the shadows of tumors and microcalcifications, can be accurately detected in a manner not dependent on the skill level of the diagnostician.

In response to this demand, anomalous shadow detection processing systems (computer aided diagnostics apparatus) that automatically detect, based on the image data of an image that has been obtained as a diagnostic image, anomalous shadows appearing within the image represented by an image data utilizing a computational device have been disclosed (e.g., U.S. Pat. No. 5,761,334). These anomalous shadow detection processing systems are apparatuses for detecting by use of a computational means the anomalous shadows appearing within a mammogram based on the characteristics of the density distribution or pattern formed thereby. Basically, an iris filtering process is employed to detect the shadows of tumors, and a morphology process is employed to detect the shadows of microcalcifications.

An iris filtering process is a process of comparing the iris filter output value representing the highest value of the concentration distribution of an image signal to a predetermined threshold value, whereby an effective method is provided for detecting the shadows of tumors characteristic of breast cancer in an image. On the other hand, a morphology process is a process of comparing the output value of a morphology computation process utilizing structuring elements of a size larger than that of the microcalcification shadows to be detected is compared to a predetermined threshold value, whereby an effective method is provided for detecting in an image the shadows of microcalcifications characteristic of breast cancer.

However, the density of mammary gland tissue structure (distribution state) in the mamma differs according to the individual; the distribution state can be divided into four types of categories: “fatty”, “scattered mammary glands”, “non-uniform high density”, and “high density”. Because the density of the mammary gland tissue structure differs for each of these categories, the density characteristics of the respective mamma regions in an image differ, which has an effect on the detection of anomalous shadows therein.

That is to say, in the case of a “fatty” image, because the mammary gland tissue structure of the mamma has been almost completely replaced with fat, the brightness of the mamma region in the image becomes low across the region, whereby the detection of abnormal shadows appearing as high-brightness shadows in the images becomes easy. Further, in the case of a “scattered mammary glands” image, because the mammary glands are in a scattered state within a mamma which has been replaced with fat, the detection of anomalous shadows is comparatively easy. On the other hand, in the case of a “non-uniform high density” image, because fat is dispersed within the mammary gland tissue structure, providing a non-uniform density, there are innumerable localized white (high-brightness) shadows resembling tumor shadows dispersed in the image, making it extremely difficult to detect anomalous shadows. Further, in the case of a “high density” image, because the entire region of the mamma comes to have a high brightness due to the fact that there is almost no fat dispersed within the mammary gland tissue structure, the detection of anomalous shadows appearing as high-brightness shadows within the image becomes difficult. However, if there is even only a little change in the locations at which anomalous shadows appear in the image recognition by use of an iris filtering process becomes easy, whereby it is possible that the anomalous shadows can be more accurately detected than in the case of non-uniform high density.

Because the ease with which anomalous shadows can be detected within the above-described types of mammary gland distributions differs, differences in the accuracy of the anomalous shadow detection results have been encountered, depending on the type of image when all images have been subjected to the same type of anomalous shadow detection process. For example, if the detection threshold value used in an iris filtering process for detecting the shadows of tumors is set at a relatively low value, even if a highly accurate result is obtained for a fatty image, there is a possibility that the detection errancy rate (number of false positives among the detected anomalous shadows) for a high density image will become high. On the other hand, if the detection threshold value is set high so as to lower the detection errancy rate for high density images, because only typical shadows are detected, the accuracy of the detection result for high density images becomes high. However, there is a possibility that the detection rate (the percentage of anomalous shadows that can be detected from among those actually present) for fatty images will become low.

### SUMMARY OF THE INVENTION

The present invention has been developed in consideration of the forgoing circumstances, and it is an object of the present invention to provide an anomalous shadow detection apparatus for detecting, based on the mammary gland distribution pattern in a mammogram, anomalous shadows appearing therein, and which is capable of reducing the fluctuation in the accuracy of the detection result.

The anomalous shadow detection apparatus according to the present invention is an anomalous shadow detection apparatus for detecting, based on image data representing a mammogram, anomalous shadows appearing in the mammogram, comprising: an image categorizing means for categorizing a mammogram according to the distribution pattern of the mammary glands appearing in the mammogram; and a detecting means for detecting, by use of the anomalous shadow detection process that has been predetermined for each mammary gland distribution pattern of the categorized mammogram, the anomalous shadows appearing in the mammogram.

Here, the referents of “anomalous shadow” can include the shadows of tumors detected by an iris filtering process, the shadows of microcalcifications detected by a morphology filtering process, and the like.

Regarding mammary gland distribution patterns, four categories can be defined: fatty, scattered mammary glands, non-uniform high density, and high density. Here, the mammary gland distribution pattern categorized by the image categorizing means can be one of the four above-described categories, or a combination of two or more thereof. That is to say, the image categorizing means can, for example, categorize an image as belonging in the fatty or “other than fatty” categories. In addition, the image categorizing means may also categorize an image as belonging in the “non-uniform high density” or “other than non-uniform high density” categories.

The predetermined detection processes of the detecting means can be determined based on the degree of difficulty in detecting the anomalous shadows occurring in each respective mammary gland distribution pattern categorized by the image categorizing means.

The degree of difficulty in detecting anomalous shadows is determined for each mammary gland distribution pattern, wherein the categories can be ordered from the category having the lowest relative degree of difficulty, i.e., fatty, scattered mammary glands, high density, and non-uniform high density. The predetermined anomalous shadow detection process can be defined according to the degree of difficulty of detection with respect to the respective mammary gland distribution pattern to be found within the images, so that the threshold value of the iris filtering process administered to each region of the mammogram or the output value of the morphology filtering process is set high the higher the degree of difficulty, whereby the number of anomalous shadows detected is made fewer the higher the degree of difficulty.

For example, because the degree of difficulty in detecting anomalous shadows from a non-uniform high density mammogram is high, the predetermined anomalous shadow detection process for a mammogram of which the mammary gland distribution pattern is categorized as being of non-uniform high density by the image categorizing means can be defined so that only the region having the highest degree of brightness within the mammogram is extracted as the sole anomalous shadow to be detected, or can be defined that no anomalous shadows are detected.

Here, the region having the highest brightness is a region of a predetermined size which is determined based on the size of the anomalous shadow targeted for detection, and which is detected as being the region having the highest brightness based on the average value or the total value of the image signal within the region.

According to the anomalous shadow detection apparatus of the configuration described above according to the present invention, a mammogram is categorized based on the mammary gland distribution pattern thereof, and the anomalous shadows appearing in the image are detected by a predetermined anomalous shadow detection process that is determined based on the category of the mammary gland distribution pattern, whereby the fluctuations in the accuracy of the detection results due to the differences in mammary gland distribution patterns can be reduced.

That is to say, by establishing in advance a predetermined appropriate anomalous shadow detection process for each type of distribution pattern, the accuracy of the detection result for each distribution pattern can be adjusted.

Further, because the degree of difficulty in detection differs for each of the categories of fatty, scatted mammary glands, high density, and non-uniform high density, if the anomalous shadow detection process is determined according to the degree of difficulty in detecting anomalous shadows occurring in the categorized mammary gland distribution patterns, the amount of fluctuation in the detection accuracy can be reduced.

Note that if the number of anomalous shadows to be detected by the predetermined anomalous shadow detection process in a mammogram that has been categorized as having non-uniform high density mammary gland distribution pattern is set at zero or one, the detection errancy rate can be reduced. That is to say, because it is extremely difficult to detect anomalous shadows from a non-uniform high density image, and there is a possibility of obtaining erroneous detection results, the detection errancy rate can be reduced if the number of regions to be detected is specified as a low number in advance.

### BRIEF DESCRIPTION OF THE DRAWINGS

FIG. 1 is a schematic drawing of an embodiment of the anomalous shadow detection apparatus according to the present invention.

### DESCRIPTION OF THE PREFERRED EMBODIMENTS

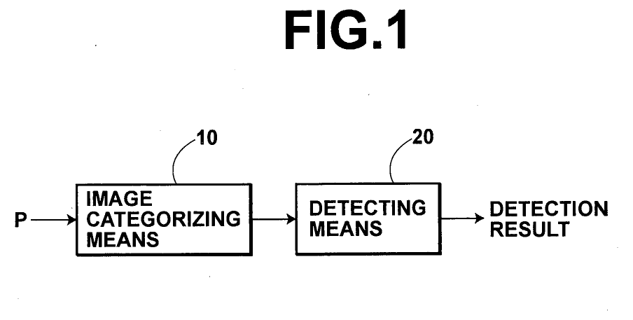

Hereinafter the preferred embodiments of the present invention will be explained with reference to the attached drawings. FIG. 1 is a schematic drawing of a specific embodiment of the anomalous shadow detection apparatus according to the present invention.

The anomalous shadow detection apparatus according to the current embodiment comprises an image categorizing means 10 for categorizing, based on an image data P representing a mammogram, an image P according to the distribution pattern of the mammary glands appearing therein; a detecting means 20 for detecting, by use of the anomalous shadow detection process that has been predetermined for each mammary gland distribution pattern of the categorized image P, the shadows of tumors appearing therein. Note that for the sake of simplicity the image data and the image represented by the image data are referred to by the same label.

Next, the operation of the anomalous shadow detection apparatus of the above-described configuration according to the current embodiment will be explained.

When a radiation image data P obtained of the mamma (i.e., a mammogram) is inputted to the image categorizing means 10, the categorization of the distribution pattern of the mammary glands appearing in the image represented by the image data P is performed automatically. For a description of a specific method, refer to the automatic categorization method that has been proposed in the article “Automated Mammogram Categorization on the Basis of the evaluation of the Disposition of the Mammary Glands” in the June, 2000 edition of “Medical Electronics and Bioengineering”, Volume 38, No. 2, pp. 1-9. The above-described automated categorization method is a method comprising the steps of: first, extracting an outline of the skin based on the image data, extracting the thorax region, and compressing the dynamic range; then, evaluating, based on a determination of the region of the location of the mammary glands by observation of the extracted skin line, the density of the mammary glands; and categorizing, based on said evaluation, the distribution pattern of the mammary glands appearing in the image represented by the image data as falling into any of four categories: fatty, scattered mammary glands, high density, and non-uniform high density.

The image categorizing means 10 groups the three categorization results fatty, scattered mammary glands and high density into a single category “other than non-uniform high density, and categorizes the inputted image data P as either “Non-uniform high density” or “Other than non-uniform high density”.

The detecting means 20 receives input of the data representing the mammary gland distribution pattern of the image data P categorized by the image categorizing means 10, and performs the anomalous shadow detection processes determined for each distribution pattern to detect the shadows of tumors. Here, when the distribution pattern is specified as being other than non-uniform high-density, three regions in the image having high brightness are detected in order, and when the distribution pattern is specified as being non-uniform high density, the brightest region (or no region at all) is detected.

When detecting regions having high brightness, round regions of a predetermined size (approximately the same size as that of the tumor shadows targeted for detection) are set with each pixel within the image as the center of said regions. Then, the average value of the brightness within the set regions is obtained, and the regions are detected in order from that having the highest brightness to those having high brightness. The detection means 20 outputs data representing the positions of the detected regions to a display apparatus or the like.

According to the anomalous shadow detection apparatus according to the current embodiment, by detecting only one (or zero) anomalous shadow region from images that have been categorized as being of non-uniform high density due to the presence therein of a large number of angular, high-brightness localized regions resembling shadows characteristic of tumors which makes detection of the anomalous shadows by brightness difficult, erroneous detections can be reduced. Note that it is desirable that another method, such as a method based on specialized knowledge, is jointly used with the method based on brightness to detect anomalous shadows from non-uniform high-density mammograms.

Further, an embodiment other than the above-described embodiment of determining in advance the number of regions detected, wherein a threshold value is set for detection by brightness and only regions having a degree of brightness higher than the threshold level are detected is also possible. In this case, the threshold value for images of non-uniform high density can be set higher than that for images of other than non-uniform high density.

Still further, aside from the above-described embodiment for detecting the shadows of tumors appearing in an image on the basis of a brightness value, an embodiment wherein the detection is performed by means of an iris filtering process is also possible. In this case also, the threshold value for images of non-uniform high density is to be set higher than that for images of other than non-uniform high density. Note that because a detailed description of a method of detecting shadows of tumors by means of an iris filtering process can be found in U.S. Pat. No. 5,761,334, a more detailed explanation thereof has been omitted here.

What is claimed is:

1. An anomalous shadow detection apparatus for detecting, based on the image data representing a mammogram, anomalous shadows appearing within said mammogram, comprising:
an image categorizing means for categorizing, based on the image data, the mammogram according to the distribution pattern of the mammary glands appearing within said mammogram, and
a detecting means for detecting, by use of the anomalous shadow detection process that has been predetermined for each mammary gland distribution pattern included in said categorized mammogram, the anomalous shadows appearing in said mammogram.

2. An anomalous shadow detection apparatus as defined in claim 1, wherein
the image categorizing means is a means for categorizing the mammogram as either an image having a mammary gland distribution pattern that is of non-uniform high density or other than non-uniform high density.

3. An anomalous shadow detection apparatus as defined in claim 1, wherein
the predetermined detection process of the detecting means are determined according to the degree of difficulty in detecting the anomalous shadows occurring in each mammary gland distribution pattern categorized by the image categorizing means.

4. An anomalous shadow detection apparatus as defined in claim 2, wherein
the predetermined detection process of the detecting means are determined according to the degree of difficulty in detecting the anomalous shadows occurring in each mammary gland distribution pattern categorized by the image categorizing means.

5. An anomalous shadow detection apparatus as defined in claim 3, wherein
the predetermined detection processes of the detecting means are processes for subjecting each region of the mammogram to a predetermined filtering process, and detecting as an anomalous shadow each region for which the output value of said filtering process exceeds the threshold value, wherein
the threshold value is set high the higher the degree of difficulty in detecting the anomalous shadows.

6. An anomalous shadow detection apparatus as defined in claim 4, wherein
the predetermined detection processes of the detecting means are processes for subjecting each region of the mammogram to a predetermined filtering process, and detecting as an anomalous shadow each region for which the output value of said filtering process exceeds the threshold value, wherein
the threshold value is set high the higher the degree of difficulty in detecting the anomalous shadows.

7. An anomalous shadow detection apparatus as defined in claim 3, wherein
the predetermined anomalous shadowing detection process for a mammogram of which the mammary gland distribution pattern has been categorized as being of non-uniform high density by the image categorizing means is a process for extracting from within said mammogram only one region having the highest degree of brightness and detecting said extracted region as an anomalous shadow.

8. An anomalous shadow detection apparatus as defined in claim 4, wherein
the predetermined anomalous shadowing detection process for a mammogram of which the mammary gland distribution pattern has been categorized as being of non-uniform high density by the image categorizing means is a process for extracting from within said mammogram only one region having the highest degree of brightness and detecting said extracted region as an anomalous shadow.

9. An anomalous shadow detection apparatus as defined in claim 3, wherein
the predetermined anomalous shadowing detection process for a mammogram of which the mammary gland distribution pattern has been categorized as being of non-uniform high density by the image categorizing means is a process that does not detect anomalous shadows.

10. An anomalous shadow detection apparatus as defined in claim 4, wherein
the predetermined anomalous shadowing detection process for a mammogram of which the mammary gland distribution pattern has been categorized as being of non-uniform high density by the image categorizing means is a process that does not detect anomalous shadows.
